(19) United States
(12) Patent Application Publication
(10) Pub. No.: US 2015/0069683 A1
(43) Pub. Date: Mar. 12, 2015

(54) Kinetic Energy Management System

(71) Applicant: Dynamic Energy Technologies, LLC, Farmington Hills, MI (US)

(72) Inventors: David J. Hochberg, Oak Park, MI (US); Gregory E. Peterson, Sylvan Lake, MI (US)

(21) Appl. No.: 14/543,201

(22) Filed: Nov. 17, 2014

Related U.S. Application Data
(62) Division of application No. 13/208,016, filed on Aug. 11, 2011.
Application No. 13/208,016 is a continuation-in-part of application No. PCT/US10/32037, filed on Apr. 22, 2010.
(60) Provisional application No. 61/372,766, filed on Aug. 11, 2010.
(60) Provisional application No. 61/171,641, filed on Apr. 22, 2009.

(51) Int. Cl. B60G 13/14; F16F 6/00; F16F 15/02; H02K 7/18

(52) U.S. Cl. CPC B60G 13/14; H02K 7/1876; F16F 6/00; F16F 15/022
USPC 267/140.11; 310/12.04

(57) ABSTRACT

A vehicle kinetic energy management system includes a first main body having a passive magnetic component movable therewith and a second main body movably attached to the first main body for reciprocal movement there between. The second main body includes an active magnetic component movable therewith and magnetically communicating with the passive magnetic component. One of the first and second main bodies being adapted for engagement with a vehicular component that experiences irregularities of a surface on which the vehicle travels, and the other main body engaging a load-bearing portion of the vehicle for which isolation from vibrations is desired. Interaction of the active and passive magnetic components in response to relative movement of the first and second main bodies translates between reciprocating kinetic energy associated with the vehicle motion over the surface irregularities and electrical energy associated with the active magnetic component.

### CROSS-REFERENCE TO RELATED APPLICATIONS

This application is a divisional of U.S. application Ser. No. 13/208,016 filed Aug. 11, 2011, which, in turn, claims the benefit of U.S. provisional application Ser. No. 61/372,766, filed on Aug. 11, 2010 and is a continuation-in-part application of Patent Cooperation Treaty Application Serial No. PCT/US10/32,037, filed Apr. 22, 2010, which, in turn, claims the benefit of U.S. provisional application Ser. No. 61/171,641, filed Apr. 22, 2009. All disclosures in these prior applications are hereby incorporated in their entirety by reference herein.

### TECHNICAL FIELD

This disclosure is related generally to energy conversion devices capable of inputting electrical and/or mechanical energy and outputting electrical and/or mechanical energy. In particular, the energy conversion device is adapted for converting one form of input energy selected from a mechanical energy and electrical energy, into an output energy selected from a mechanical energy and electrical energy using a stationary and moveable magnetic component. This disclosure is further related generally to energy management systems capable of managing kinetic energy in the form of vibrating mechanical input. In particular, this disclosure is directed to energy management systems for absorbing transverse shock or vibration experienced by a moving vehicle.

### SUMMARY

At least two nested magnetic components, such as toroidal magnetic components are provided, one active component creating a magnetic field and one passive component, from which the energy of the field is converted to mechanical energy or vice versa through relative movement between the active and passive component. The passive component may be a magnetic piston and the active component may be a coiled electrical winding.

For conversion of mechanical energy into electrical energy, external forces, originating from source of kinetic energy such as walking, running, driving, typing, or the movement of air or water, or the expansion or contraction of a fluid, may cause a floating magnet to oscillate relative to a winding or coil. For example, mechanical energy from wind, hydro or other moving fluid or from mechanical activity may be used to cause relative movement between the piston and the winding and energy generated by the relative motion may be transferred from the winding to and stored as electrical energy by an electrical storage device such as a battery or a capacitor. For conversion of electrical energy into mechanical energy, electrical energy from an external source causes the winding to create a magnetic field which causes the floating magnet to move. The mechanical energy is used directly or stored by a mechanical energy storage device such as a flywheel.

In one exemplary device, a winding or coil defines a longitudinal axis. Two fixed magnets, one disposed at each end of the longitudinal axis, act on a magnetic piston movably disposed relative to the winding and displaceable along the longitudinal axis. The relative motion between the piston and the winding may be horizontal or vertical or at any angle therebetween.

In another exemplary device, the energy conversion device has an elongated channel defined by a radial magnetic source, a winding disposed coaxial with the radial magnetic source two oppositely disposed axial magnets in fixed locations at opposing ends of the elongated channel and a piston disposed therebetween. The radial axial magnets may be rare earth magnets such as neodymium magnets.

In another exemplary device, a passive toroidal component is significantly larger than an active toroidal component.

In still another exemplary device, the piston may be a complex magnet having an axial magnetic component responsive to the oppositely disposed axial magnets, and a radial magnetic component responsive to the radial magnetic source to generally maintain the piston in a floating position within an elongated channel defined by the winding or coil. The opposing magnetic fields of the oppositely disposed axial magnets confine the floating piston within the channel and increase the number and speed of the oscillations. A cylinder may be provided defining the channel and may be wrapped tightly with a toroidal copper winding defining the winding. As the piston passes through the winding, its movement creates a moving magnetic field that is converted into electrical current flowing through the winding.

Additional magnets may be configured around the cylinder allowing the piston to float freely, reducing friction between the piston and the walls of the cylinder.

A kinetic energy management system is also disclosed for managing vibration experienced by a moving vehicle, where the vibration occurs in a direction generally transverse to the direction of movement of the vehicle,

One exemplary kinetic energy management system includes an electromechanical shock absorber device comprising a first main body movably attached to a second main body for reciprocal movement therebetween, the first main body having a winding or coil movable therewith and the second main body having a magnet moveable therewith. The magnet may be movable relative to the winding by the reciprocal relative movement of the first and second main bodies such as to generate a current in the winding. One of the first or second main bodies is adapted for engagement with a vehicular component that experiences the irregularities of a surface on which the vehicle travels and the other of the main bodies is adapted for engagement with a load bearing portion of the vehicle for which isolation from the vibrations due to irregularities of the surface is desired. The interaction of the magnet and the winding may be used to translate between reciprocating kinetic energy associated with the motion of the vehicle over the surface irregularities and electrical energy associated with current through the winding. The vehicle may be a car or truck and the surface may be a road. Alternatively, the vehicle may be a boat and the surface may be the surface of a body of water.

Another exemplary kinetic energy management system includes an electromagnetic shock absorber having at least two nested magnetic components, such as toroidal magnetic components, one active component creating a magnetic field and one passive component from which the energy of the field is converted to mechanical energy, or vice versa through relative movement between the active and passive component. The passive component may be a magnetic piston and the active component may be a coiled electrical winding. For conversion of kinetic energy into electrical energy, external forces, originating from surface irregularities as a vehicle travels in a forward direction, cause relative movement between the magnetic components resulting in current flowing through the active component.

In another electromechanical shock absorber, a winding or coil defines a longitudinal axis. Two fixed magnets, one disposed at each end of the longitudinal axis, act on a magnetic piston movably disposed relative to the winding and displaceable along the longitudinal axis, The relative motion between the piston and the winding may be horizontal or vertical or at any angle therebetween.

In still another exemplary system, the electromechanical shock absorber has an elongated channel defined by a radial magnetic source, a winding disposed coaxial with the radial magnetic source, two oppositely disposed axial magnets in fixed locations at opposing ends of the elongated channel and a piston disposed therebetween. The radial axial magnets may be rare earth magnets such as neodymium magnets.

The energy management system may be used to passively absorb a portion of the transverse vibration by surface irregularities as well as to provide electrical energy for later use by passively converting the kinetic energy to electricity. Alternatively, the energy management system may be used to actively manage the amplitude or the frequency of the transverse vibrations experienced by the load-bearing portion of the vehicle by selective application of a current to the windings. The energy management system may therefore include an electronic control system to control the application of current to the winding as well as to regulate the use of current generated in the winding by the movement of the magnet

The first and second main bodies of the electromagnetic shock absorber may create an enclosure or housing for the magnet, the winding, electronic controls, shock-absorbing components, and a spring. The main body may be constructed to have a similar shape and mounting function as a conventional mechanical shock absorber or may have alternate shapes and features for special applications.

The magnet may be a disc shaped compound complex radial magnetic piston manufactured or selected to effectively present axial poles of opposing polarity on its respective faces as well as to effectively present a radial pole of a single polarity.

In still another exemplary device, the piston may be a complex magnet having an axial magnetic component responsive to the oppositely disposed axial magnets, and a radial magnetic component responsive to the radial magnetic source to generally maintain the piston in a floating position within an elongated channel defined by the winding or coil. The opposing magnetic fields of the oppositely disposed axial magnets confine the floating piston within the channel and increase the number and speed of the oscillations. A cylinder may be provided defining the channel and may be wrapped tightly with a toroidal copper winding defining the winding. As the piston passes through the winding, its movement creates a moving magnetic field that is converted into electrical current flowing through the winding.

Additional magnets may be configured around the cylinder allowing the piston to float freely, reducing friction between the piston and the walls of the cylinder.

The energy management system may be used in parallel or in series with a mechanical energy managing system such as a mechanical shock absorber or a mechanical spring. Alternatively, a mechanical energy managing system may be integrated into a shock-absorbing device of the type disclosed herein.

In one exemplary energy management system disclosed, the vehicle using an electromagnetic shock absorber is a car or truck and the surface is a road. The electromagnetic shock absorber is installed in parallel with a conventional mechanical shock absorber or spring. Alternatively, the electromechanical shock absorber incorporates mechanical shock absorbing components and is substituted for a conventional mechanical shock absorber. Alternatively, the electromechanical shock absorber incorporates a spring and is substituted for a conventional mechanical spring.

In another exemplary embodiment, the vehicle is a boat and the surface is the surface of a body of water. An electromechanical shock absorber may be installed between the hull of the boat and a pontoon floating on the surface of the water adjacent the hull. A plurality of electromechanical shock absorbers may be provided adjacent each side of the boat coupled to one or more pontoons on each side of the boat. The action of waves will displace the magnet relative to the windings of the electromechanical shock absorbers to induce current in the windings to generate electrical power or to provide a damping effect on the motion of the boat in response to the waves. The windings of the electromechanical shock absorbers may also be selectively powered to raise the pontoons above the water surface when desired.

### BRIEF DESCRIPTION OF THE DRAWINGS

Some configurations of the energy management system will now be described, by way of example only and without disclaimer of other configurations, with reference to the accompanying drawings in which:

FIG. 1A is a schematic representation of an energy conversion device;

FIG. 1B is a schematic representation of an alternative energy conversion device;

FIG. 2 is a side elevational view of a first example of an energy conversion device, with internal magnetic components shown in phantom line;

FIG. 3 is a sectional view of the energy conversion device of FIG. 2 taken along line 3-3 thereof;

FIG. 4 is a sectional view of the energy conversion device of FIGS. 2 and 3 taken along line 4-4 of FIG. 3;

FIG. 5 is a side elevational view of a second example of an energy conversion device, with internal magnetic components shown in phantom line;

FIG. 6 is a sectional view of the energy conversion device of FIG. 5 taken along line 6-6 thereof;

FIG. 7 is 1 sectional view of the energy conversion device of FIGS. 5 and 6 taken along line 7-7 of FIG. 6;

FIG. 8 is a top view of an alternative complex piston for the energy conversion devices of FIGS. 1 through 6;

FIG. 9 is a schematic view of a prior art automotive shock absorbing system including conventional mechanical shock absorbers;

FIG. 10 is a schematic view of a conventional mechanical shock absorber illustrating the operation thereof with its internal components in an extended operational configuration;

FIG. 11 is a schematic view of the shock absorber of FIG. 10 with its internal components in a compressed operational configuration;

FIG. 12 is a schematic perspective view of a conventional shock absorber mounted in parallel with an exemplary electromagnetic shock absorber;

FIG. 13 is a schematic perspective view' of a conventional shock absorber mounted in parallel with an alternative exemplary electromagnetic shock absorber;

FIG. 14 is a schematic perspective view of another alternative exemplary electromechanical shock absorber which may be substituted for a conventional mechanical shock absorber;

FIG. 15 is a sectional view of the electromagnetic shock absorber of FIG. 12 taken along line thereof;

FIG. 16 is a partial sectional view of the electromagnetic shock absorber of FIGS. 12 and 15 taken along line 16-16 of FIG. 15;

FIG. 17 is an exploded schematic view of certain internal components of the electromagnetic shock absorber of FIGS. 12, 15 and 16;

FIG. 18 is an exploded schematic view similar to FIG. 17, but illustrating an alternative exemplary electromagnetic shock absorber;

FIG. 19 is a sectional view similar to FIG. 15, but illustrating another alternative exemplary electromagnetic shock absorber with control components incorporated into its housing;

FIG. 20 is a sectional view similar to FIG. 15, but illustrating still another alternative exemplary electromagnetic shock absorber with damping components incorporated into its housing;

FIG. 21 is a sectional view similar to FIG. 15, but illustrating yet another alternative exemplary electromagnetic shock absorber with damping components and a spring incorporated into its housing;

FIG. 22 is a perspective view of an exemplary linear kinetic energy management system including an electromechanical shock absorber for use in association with a boat;

FIG. 23 is a perspective view of an alternate exemplar kinetic energy management system including a plurality of electromechanical shock absorbers for use in association with a boat;

FIG. 24 is a side elevational view of the kinetic energy management system of FIG. 23;

FIG. 25 is a top plan view of the kinetic energy management system of FIGS. 23 and 24;

FIG. 26 is a front elevational view of the kinetic energy management system of FIGS. 23-25, illustrating the kinetic energy management system mounted to a side of a boat; and

FIG. 27 is a sectional view through yet another kinetic energy management system having an electromagnetic shock absorber into a float.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention. Referring now to the drawings; exemplary energy management systems are shown in detail. Although the drawings represent alternative configurations of energy management systems, the drawings are not necessarily to scale and certain features may be exaggerated to provide a better illustration and explanation of a configuration. The configurations set forth herein are not intended to be exhaustive or to otherwise limit the device to the precise forms disclosed in the following detailed description.

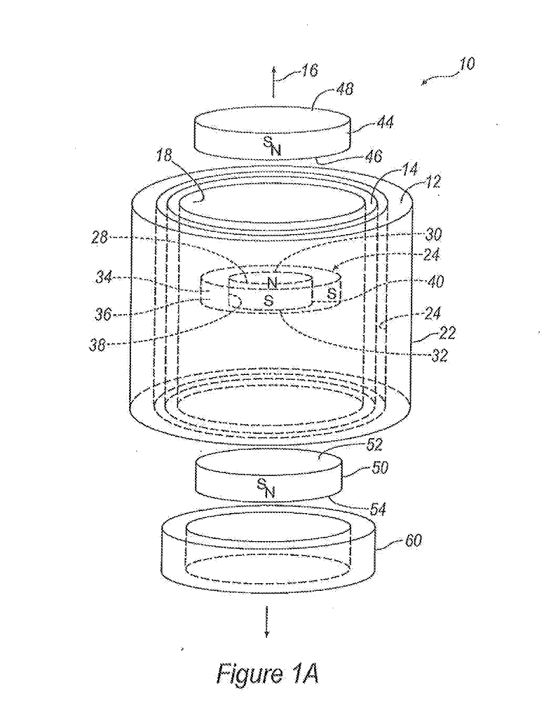

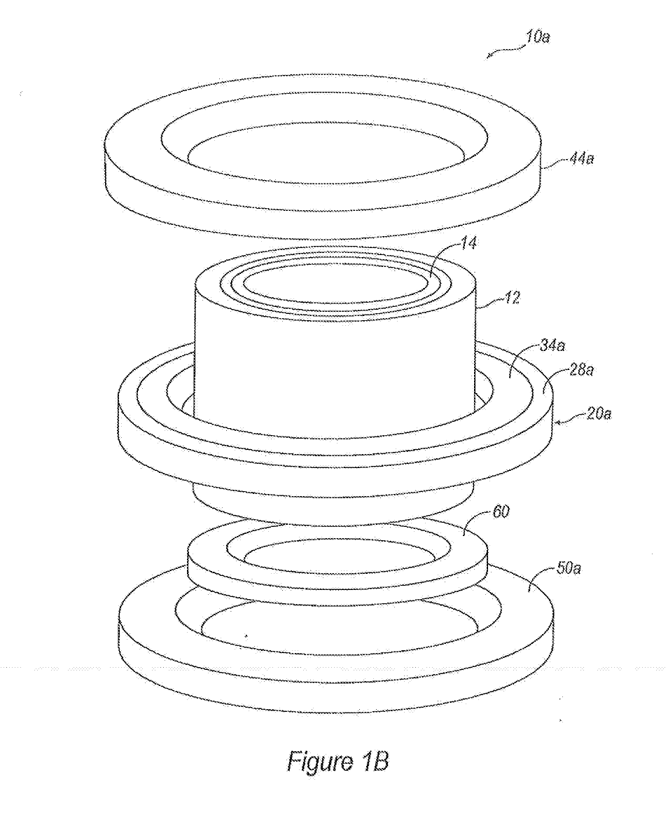

Referring to FIG. 1A, schematically illustrating a generalized energy conversion device 10, the arrangement of the magnetic and electromagnetic components of energy conversion device 10 will be described. In particular, energy conversion device 10 includes a radial magnetic source 12 disposed coaxially with a winding such as a toroidal winding 14. In the exemplary structure illustrated, radial magnetic source 12 surrounds toroidal winding 14. Together, radial magnetic source 12 and a toroidal winding 14 define a longitudinal axis 16 as well as an elongated channel 18 for a piston 20 to reciprocate along longitudinal axis 16. Radial magnetic source 12 has an outer circumferential surface 22 having a first polarity and an inner circumferential surface 24 having an opposite polarity to outer circumferential surface 22. As described below, radial magnetic source 12 may, for example, be a single elongated toroidally shaped magnet or may be a plurality of bar-shaped magnets disposed radially about toroidal winding 14. In some applications, the energy conversion device may be used without a radial magnetic source 12.

Piston 20 comprises a disk-shaped axial magnet 28 having a first surface 30 of a first polarity and a second surface 32 of an opposite polarity to that first surface 30. Piston 20 further comprises a toroidally-shaped radial magnet 34 surrounding axial magnet 28 and having an outer circumferential surface 36 of a first polarity and an inner circumferential surface 38 of a second polarity opposite the polarity of surface 38. Inner circumferential surface 38 engages an outer circumferential surface 40 of axial magnet 28. Radial magnet 34 interacts with radial magnetic source 12 to maintain piston 20 axially centered in channel 18. This will occur whether the inner circumferential surface 24 of radial magnetic source 12 has the same polarity or the opposite polarity as the outer circumferential surface 36 of radial magnet 34, since the forces will be approximately equal in all directions, but piston 20 will be less likely to tilt relative to longitudinal axis 16 due to any imbalance of forces if these surfaces have opposite polarity.

It should be noted that all of the magnets used in the energy conversion device may be rare earth magnets, such as neodymium magnets, to provide the desired strength combined with a low-weight. Alternative choices for the neodymium material are described later herein.

A disk-shaped axial magnet 44 is disposed at one longitudinal end of channel 18. Axial magnet 44 has a first surface 46 facing towards first surface 30 of axial magnet 28 of piston 20 and having the same polarity as first surface 30 so as to repel piston 20. Axial magnet 44 has a second surface 48 disposed opposite to first surface 46 and having the opposite polarity as first surface 46. A disk shaped axial magnet 50 is disposed at the other longitudinal end of channel 18. Axial magnet 50 has a surface 52 facing towards second surface 32 of axial magnet 28 of piston 20 and having the same polarity as second surface 32 so as to repel piston 20. Axial magnet 50 has a second surface 54 disposed opposite to first surface 52 and having the opposite polarity as first surface 52.

Therefore, as depicted in FIG. 1A, axial magnets 44 and 50 cooperate with axial magnet 28 of piston 20 and radial magnetic source 12 cooperates with radial magnet 34 of piston 20 to maintain piston 20 floating in a fixed position within channel 18 unless disturbed by an external force. Furthermore, if any event causes a repositioning of piston 20 relative to any of the magnet components 12, 44 or 50, the net magnetic forces upon piston 20, taking also into account the force of gravity piston 20, will cause piston 20 to oscillate within channel 18 along longitudinal axis 16 until it is restored to a balanced stationary position. As piston 20 oscillates, toroidal winding 14 generates electrical energy from the moving magnetic field. Since piston 20 is free floating within channel 18, no energy is lost to friction between solid bearing surfaces.

Energy conversion device 10 further includes another toroidal winding 60 disposed adjacent axial magnet 50. Toroidal winding 60 may be selectively energized to temporarily upset the balance of forces acting on piston 20 so as to initiate or assist the oscillation of piston 20. It will be appreciated that oscillation of piston 20 may additionally or alternatively be initiated or assisted by mechanical action causing piston 20 to move relative to the other magnetic components 12, 44 and 50, or alternatively causing any of the magnetic components 12, 44 and 50 to move relative to piston 20. It will further be appreciated that relative motion between piston 20 and toroidal winding 14 will establish a current in toroidal winding 14 which may be used as a source of electrical power.

FIG. 1B schematically illustrates an alternative generalized energy conversion device 10a in which the arrangement of the magnetic and electromagnetic components are similar to those described above except that piston 20a and axial magnets 44a and 50a are ring-shaped. In this arrangement, piston 20a is disposed outside of the radial magnetic source 12 and the toroidal winding 14 and axial magnet 50a is disposed outside of toroidal winding 60. Piston 20a is composed of an inner ring-shaped radial magnet 34a and an outer ring-shaped axial magnet 28a. Axial magnets 44a and 50a interact with axial magnet 28a and radial magnetic source 12 interacts with radial magnet 34a according to the same principles as the similarly numbered components of the generalized energy conversion device 10 of FIG. 1A described above.

It should be noted that a plurality of toroidal windings are provided. One or more passive toroidal windings are provided to create an output current as a function of the motion of the piston. One or more active toroidal windings are provided to create a magnetic field opposing the magnetic field of the piston. The passive toroidal winding is significantly larger than the active toroidal winding. The energy created by the piston interacting with the passive toroidal winding may be transferred to and stored in an electrical device such as a battery or capacitor. The active toroidal winding may use the electrical energy previously created by the moving piston magnets interacting with the passive toroidal winding.

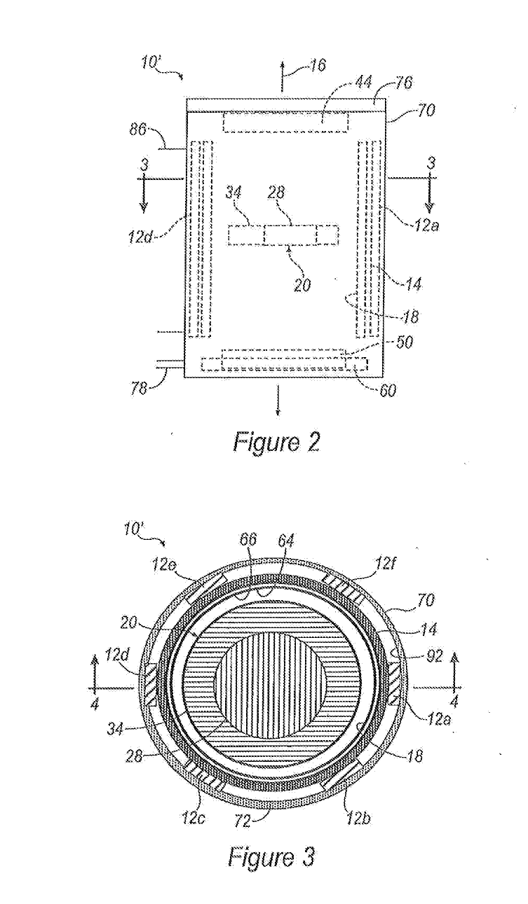

Referring now to FIGS. 2-4, a first exemplary energy conversion device 101 will be described.

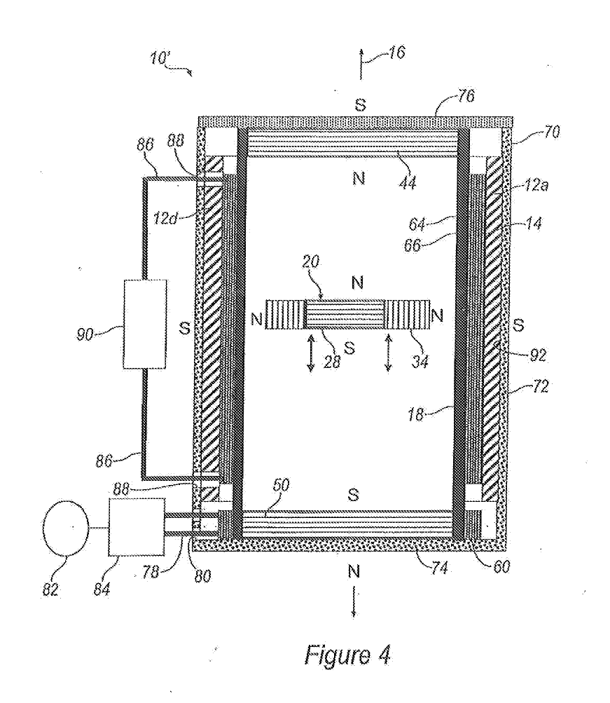

As shown in FIGS. 3 and 4, toroidal winding 14 is wound about and supported by a tube 64 formed of a suitable non-conductive material such as plastic. As shown only in FIG. 4, toroidal winding 60 may also be wound about and supported by tube 64. An inner surface 66 of plastic tube 64 defines channel 18 for piston 20.

As best shown in FIG. 4, energy conversion device 10′ is provided with an outer housing 70 having a cylindrical wall 72 closed at one end by a flat wall 74 and attachable at another end with a cover 76 to form an enclosure for the magnetic components of energy conversion device 10. Axial magnet 44 is affixed to cover 76. Axial magnet 50 is affixed to base 74 inside of outer housing 70. Piston 20 is shown spaced away from toroidal winding 14 so as to avoid loss of energy to friction between components. However, piston 20 may be proportioned with a sufficiently large diameter relative to the inner diameter of toroidal winding 14 to restrict airflow between the portions of channel 18 on either side of piston 20. To prevent air pressure buildup on either side of piston 20 from inhibiting the motion of piston 20, housing 70 may be provided with openings, not shown, permitting airflow to on either end of channel 18.

Wires 78 (see FIGS. 2 and 4) for powering toroidal winding 60 extend through apertures 80 in cylindrical wall 72 to an external power source 82, as shown in FIG. 4. Power source 82 may be selectively connected to toroidal winding 60 through a switch 84, which may be a manual switch or may be a switch activated automatically, such as by a microprocessor, when it is desired to introduce a temporary magnetic imbalance to piston 20 to initiate or assist in the oscillation of piston 20. Wires 86 (see FIGS. 2 and 4) connected to toroidal winding 14 similarly extend through apertures 88 in cylindrical wall 72 to an electrical load 90, as shown in FIG. 4. Alternatively, wires 86 may be replaced by a wireless power transmission system.

Energy conversion device 10′ may be configured to provide either alternating current or direct current output. Electrical load 90 may be one or more electrical devices capable of consuming the power, one or more storage devices used to store power for later use, or a power distribution system. Exemplary storage devices for electrical load 90 include batteries, flywheels, capacitors, and other devices of capable of storing energy using electrical, chemical, thermal or mechanical storage systems. Exemplary electrical devices for electrical load 90 include electric motors, fuel cells, hydrolysis conversion devices, battery charging devices, lights, and heating elements. Exemplary power distribution systems electrical load 90 includes residential circuit breaker panel, or an electrical power grid. Electrical load 90 may also include intermediate electrical power conversion device capable of converting the power to a form useable by electrical load 90 such as an inverter.

While power source 82 and electrical load 90 are schematically illustrated as independent of energy conversion device 10′, either or both may be integrated with energy conversion device 10′ or connected with energy conversion device 10′ in some manner. In particular, one or both may alternatively be affixed to outer housing 70 or cover 76 or mounted within a compartment formed on outer housing 70 or cover 76. Still another alternative would be for the power source 82 or electrical load 90 to incorporate cover 76. Furthermore, while power source 82 and electrical load 90 are schematically illustrated as being tangentially located relative to longitudinal axis 16, either or both may be advantageously located along longitudinal axis 16 for some implementations. Thus, for example, but not illustrated, cylindrical wall 72 of outer housing 70 may extend beyond wall 74 to provide a compartment for the storage of a power source 82 or electrical load 90, such as cylindrical batteries, radio, or a light. Additionally or alternatively, cover 76 may be provided with a compartment or attachment feature for a power source or an electrical load.

Energy conversion device 10′ may use six equally spaced bar magnets 12a through 12f disposed about the periphery of toroidal winding 14 as a radial magnetic source. An inner wall 92 of outer housing 70 holds the array of bar magnets in their desired spaced apart relationship.

Energy conversion device 10′ may therefore be assembled, as shown in FIG. 4 by inserting piston 20 into outer housing 70, sliding tube 64 carrying toroidal windings 14 and 60 and piston 20 into outer housing 70, and then attaching cover 76 to close outer housing 70.

Housing 70 may be provided with appropriate legs or mounting points, not shown, if desired, for selectively supporting energy conversion device 10′ in a horizontal position, a vertical position, or both. If the intent is to operate energy conversion device 10′ with longitudinal axis 16 vertically disposed, then it may be desirable to select an axial magnet 50 that is stronger than axial magnetic component of piston 20 and to select an axial magnet 44 that is weaker than axial magnetic component of the piston 20 to adjust for the gravitational force on piston 20.

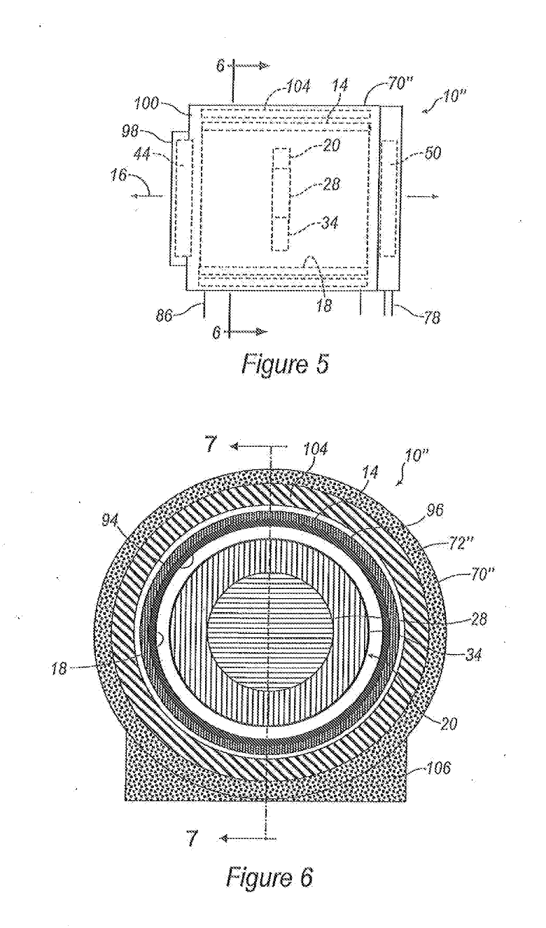

Referring now to FIGS. 5-7, a second exemplary energy conversion device 10″ will be described. Energy conversion device 10″ is similar to energy conversion device 10′ except as described below.

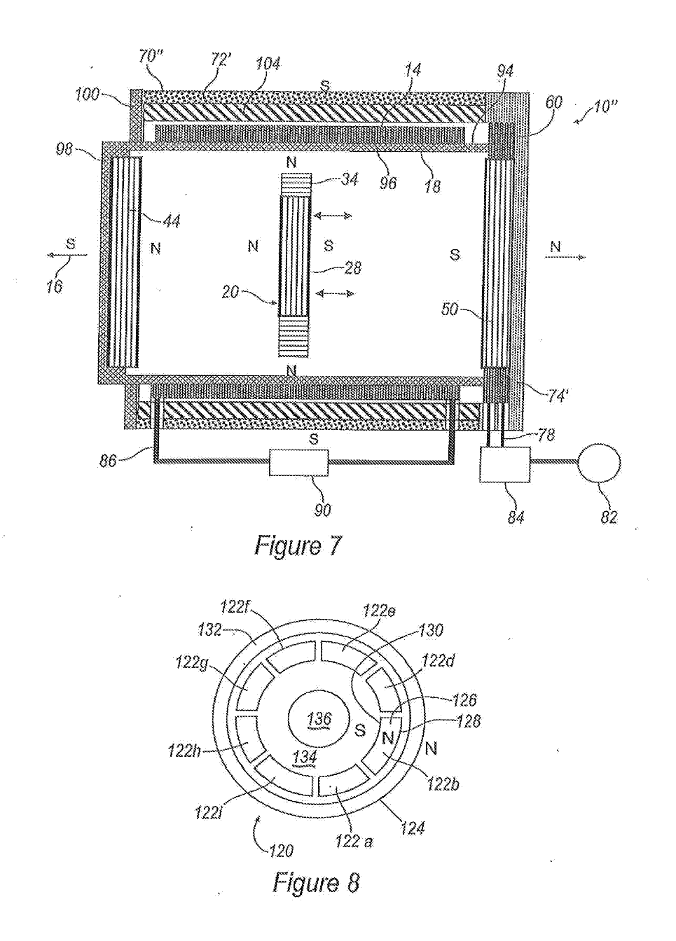

As shown in FIGS. 6 and 7, toroidal winding 14 is wound about and supported by a cylindrical wall 94 of an inner housing 96. Inner housing 96 is formed of a suitable non-conductive material Inner housing 96 has a flat wall 98 (see FIGS. 5 and 6) closing one end of cylindrical wall 94 and an annular flange 100 extending from cylindrical wall 94. Cylindrical wall 94 of inner housing 96 defines channel 18 for piston 20. Axial magnet 44 is affixed to flat wall 98 within inner housing 96.

An outer housing 70″ having a cylindrical wall 72′ (see FIG. 7) joined to a flat base 74′ provides a partial enclosure for the magnetic components of energy conversion device 10″ in a manner similar to outer housing 70 (see FIGS. 2, and 4) of energy conversion device 10′, except that instead of a cover 76, the open end of outer housing 70″ (see FIGS. 5 and 7) is closed by annular flange 100 of inner housing 96.

Energy conversion device 10″ further differs from energy conversion device 10′ in that, instead of using six bar magnets, energy conversion device 10″ uses an elongated toroidal magnet 104 fitted into outer housing 70″ as a radial magnetic source. Energy conversion device 10″ further differs from energy conversion device 10′ by having a support 106 (see FIG. 6) extending from the cylindrical wall 72″ to selectively support energy conversion device 10″ on a horizontal surface. It will be appreciated that, unlike energy conversion device 10′ which is designed to advantageously use the force of gravity on piston 20, energy conversion device 10″ may be positioned at any orientation from zero to ninety degrees relative to a horizontal plane and, if desired, support 106 may be omitted. As shown, toroidal winding 60 may be wound about axial magnet 50. Alternatively, not shown, toroidal winding 60 may be wound about cylindrical wall 94 of inner housing 96 or around a spool.

Energy conversion device 10″ may therefore be assembled, as shown in FIG. 7, by sliding toroidal magnet 104 and piston 20 into outer housing 70″, inserting inner housing 96 into outer housing 70″, and then attaching annular flange 100 to outer housing 70″.

Energy conversion devices 10, 10a, 10′ and 10″ may be used as a generator, a motor, a pump, a compressor, an engine, or an electrical power transformer. When used as a transformer, electrical power may be input to toroidal winding 60 and electrical power may be output from toroidal winding 14. When used as a generator, mechanical power may be input by reciprocally moving the outer housing 70 or 70″ along axis 16 and electrical power may be output from toroidal winding 14. The mechanical motion may be provided, for example, by any source that is capable of oscillating the housing along longitudinal axis 16, such as ocean waves, wind, reciprocating fuel burning engines or manual activity. Alternatively, mechanical motion may be imparted to the piston 20 or 20a. For example the two ends of housing 70 or 70″ may have openings, not shown to allow the movement of air into the channel 18 on one side of the piston and out of the channel 18 on the other side of the piston such as to impart movement to the piston as a result of pressure differential across the piston. The output of the energy conversion device can be configured to be direct or alternating current.

When used as a motor, electrical power, for example from power lines, solar, wind, or stored energy may be input to toroidal winding 60 or through toroidal winding 14 to cause vibration or reciprocal motion of piston 20 or 20a and a reactionary motion of outer housing 70 or 70″. Mechanical power may be harnessed through a coupling to piston 20 or 20a or alternatively through using or harnessing the reciprocal motion or' vibration of the outer housing 70 or 70″, which may occur in reaction to the motion of piston 20 or 20a. When used as a pump or compressor, suitable valve passageways, not shown, may be provided to permit piston 20 or 20a to pump air or another fluid or to compress a fluid.

An energy conversion device may be configured as a single stage having a single set of axial magnet 50, a single set of toroidal windings 14 and 60, a single radial magnetic source 12, and a single piston 20 or 20a, as described above. Alternatively, a compound energy conversion device, not illustrated, may have multiple stages, each with at least its own piston, which may operate in series, in parallel, or independently. When constructed with multiple stages, the individual stages may share components, such as outer or inner housings. The multiple stages may be axially aligned with each other such as, for example, by having multiple stages similar to energy conversion device 10, 10a, 10′ or 10″ extending sequentially along longitudinal axis 16 or by having one or more ring-type energy conversion devices 10a disposed concentrically about a central energy conversion device 10, 10a, 10′ or 10″. Alternatively, multiple energy conversion devices may be connected electrically or mechanically in parallel or in series.

Refer now to FIG. 8 illustrating an alternative complex magnet 120 formed of a plurality of magnetic segments 122a-122f enclosed in a ring 124. Complex magnet 120 may be a radial neodymium ring magnet of the type sold by Engineered Concepts, 1836 Canyon Road, Vestavia Hills, Ala. 35216, owned by George Mizzell in Birmingham, Ala., and offered for sale under the name SuperMagnetMan, for example, as parts number RROU60N, RR0090N, or, RR0100S. Complex piston 120 may be used in any of the energy conversion devices 10, 10a, 10′ or 10″.

Applicants have determined experimentally that such magnets have the property of having an axial magnetic component such as to effective presenting a north pole on one face 126 and a south pole on an opposite face not shown while also having a radial component presenting a first pole, such as a north pole on first arcuate face 128, and an opposite pole such as a south pole, on a second arcuate face surface 130.

In particular, complex magnet 120 may be manufactured using multiple magnet sections 122a-f which are created individually and then assembled into ring 124. Ring 124 may be comprised of aluminum and have an outer cylindrical wall 132 and at least one annular wall 134 for engaging the magnetic sections Annular wall 134 may have a centrally located aperture 136 for use in mounting complex magnet to other components, such as a shaft, when required for some applications. When used with energy conversion device 10a, shown in FIG. 1B, aperture 136 will be large enough to clear coil or winding 14 as well as radial magnetic source 12, if a radial magnetic source is used.

For example, an acceptable complex piston has been manufactured using ten separate N42 diametric magnet segments. For some applications, a weaker complex piston may be suitable made from N40 or N32 segments, since it is easier to assemble using weaker magnet segments. It has been suggested experimentally that such variables as the gauss strength, strength and length of the piston 120 magnetic field, as well as the speed (oscillations) of the radial magnet be maximized. The addition of a second radial magnet also appears experimentally to be helpful. However, from experiments to date, it appears that the most important variables to maximize are the gauss strength and radial magnetic strength and therefore a piston made from N52 may be desirable,

It will be appreciated that the energy storage device described above may be acting in concert with and providing an input either primary or secondary, to an individually circuited system such as a residential home fuse panel fed by a commercial power grid or to a hydro, nuclear, wind, solar, wave, or any other type of electrical power generation grid such as used for private and/or public power consumption. The device may be a singular entity or multiple entities combined as units in series, parallel or independently to provide increased output. The device may be capable of acting in concert with an electrical device capable of calculating and regulating the input energy to the active toroid 60 such that the piston motion is maintained. The device may, acting in concert with an electrical device (e.g., an electronic control module capable of being programmed) be capable of calculating and regulating the input energy to the active toroid (60), reading input signals and generating output signals based on the input signals such that the piston motion is decelerated, stopped and reversed with minimum input energy to the active toroid.

A control algorithm may be provided capable of deriving piston deceleration and acceleration and calculating the required toroidal energy needed to accelerate the piston to its required velocity and generating a current and voltage input signal for the active toroid. The algorithm would minimally require input signals consisting of piston travel at three different positions, e.g., using Hall affect sensors, each sensed position being past the piston mid-travel point along the longitudinal axis toward a horizontal magnet, calculating the time between the three pulses to derive velocity and deceleration for two time periods, calculating the deceleration rate as a function of piston position, calculating the point at which the piston will stop, determining the force necessary to accelerate the piston to the desired initial velocity, calculating the required toroid force required generating a current command signal (for a fixed voltage) and measuring the acceleration as the piston travels in the opposite direction along its longitudinal axis and adjusting the toroidal power level to maintain the required piston target velocity by measuring the time required to travel between the three points.

The energy conversion device may be adapted, in concert with control algorithms, to minimize the input energy into the active toroid. The control algorithm may maintain the following relationship: Fₜᵢₙ>Fₚ−F_{Mh} where Fₜᵢₙ is the active toroid force in a direction opposite that of the piston force 20 proportional to input voltage and current, Fₚ is the piston force, and F_{Mh} is the force of the horizontal magnet opposing the piston force Fₚ such that a piston traveling along its longitudinal axis is decelerated as it approaches a horizontal magnet (such as magnet 50), stops instantaneously and then is accelerated by the active toroid 60, (see FIG. 1A) at a predetermined, empirically developed rate by the applied force Fₜᵢₙ, acting in concert with the repelling force of the horizontal magnet 50, towards the upper horizontal magnet 44.

Acting in concert with a stationary magnet or magnets 44 and 50 (as shown in FIG. 7) the longitudinal axis of this device, including these magnets, can be oriented from 0-90 degrees relative to a horizontal plane, displaced a finite distance from the vertical mid-point whose primary force fields are oriented 90 degrees from the radial magnets, said magnets located such that their fields interact with the radial magnets along the vertical axis of the radial magnets as shown in the exemplary device of FIGS. 1-7. This magnet or magnets can be positioned either internal to the stationary radial magnets (as illustrated) or external to the stationary radial magnets, i.e., the magnet has a larger ID than the stationary radial magnet OD using a ring type magnet configuration.

It is to be understood that the above description is intended to be illustrative and not restrictive. Many configurations and applications other than the examples provided would be apparent to those of skill in the art upon reading the above description. For example, it will be appreciated that relative motion between the piston and the winding may be caused by any mechanical action such as wind, hydro (wave, current or vertical drop energy), or mechanical input from moving or bouncing objects. Alternatively, the energy conversion device may transmit power to a device or devices capable of utilizing the electrical output of the toroid without using intermediate storage. These devices include, but, are not limited to, electric motors, fuel cells, hydrolysis conversion devices, battery charging devices, lights, and heating elements. Alternatively, the piston may be directly displaced by a fluid acting directly on a face of the piston, such as moving air or water, a combustible fuel expanding against one face of the piston, or a fluid expanding or contracting in response to a temperature change.

Still another variation is providing the energy conversion device within a portable electronic device to directly provide power to the device or to charge a battery within the device. Such energy conversion devices may generate power from intentional or incidental movement of the device by a person carrying the portable electronic device or a vehicle in which the portable electronic device is carried, such as by shaking the device along the longitudinal axis of the energy conversion device. For such applications, the energy conversion device may be proportioned as a standard cylindrical battery, such as standard A, B or C batteries, and may further be provided with output and input features comparable to such batteries so that they may be substituted for such batteries or placed in series with such batteries in the portable electronic device. Alternatively, the energy storage device may be proportioned to substitute for two or more such batteries. Alternatively, a combination system of a rechargeable battery and an energy conversion may be incorporated into a self-recharging battery pack for installation in a portable electronic device. The self-recharging battery pack may be proportioned and fitted with appropriate electrical connectors to substitute for one or more conventional batteries. Such self-recharging battery packs may be provided with an indicator to indicate when the battery is charged or a control system to allow power to be drawn from the battery only when the battery is charged above a predetermined threshold.

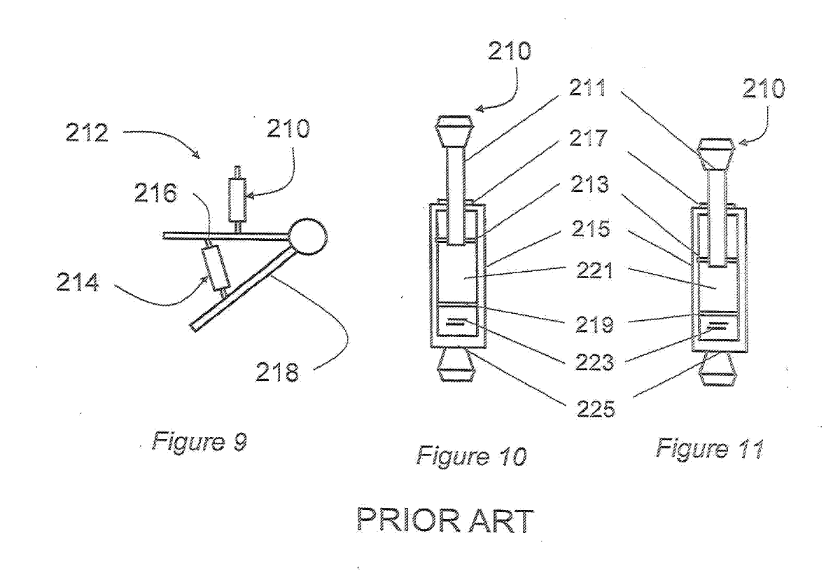

Referring now to FIG. 9, which schematically illustrates an example of a prior art automotive energy management system 212 using conventional mechanical shock absorbers 210 to isolate the load bearing portion of a vehicle, such as a passenger compartment, from the vibrations of the wheel and axle system experienced as the vehicle moves in a forward direction over an uneven road surface. As shown in FIG. 9, prior art energy management systems 212 may include a spring 214, such as a coil spring or a leaf spring, to further manage the vibration between suspension components 216 and 218.

FIGS. 10 and 11 schematically illustrate a conventional mechanical shock absorber 210 with its internal components in an extended and compressed configuration, respectively. As illustrated, conventional mechanical shock absorber 210 typically has a rod 211 having a piston 213 on its extreme end reciprocally mounted in a cylinder 215 such that piston 213 sealingly engages an inner wall of cylinder 215. A seal 217 is also provided between the free end of rod 211 and an end 225 of cylinder 215 receiving rod 211. A floating piston 219 divides cylinder 215 into an oil reservoir 221, in which piston 213 is free to oscillate along the longitudinal axis of cylinder 215, and an air chamber 223 disposed remote from piston 213. As seen by comparing FIG. 10 and FIG. 11, the oil in reservoir 221 resists the motion of piston 215 in response to vibration input to shock absorber 210, thereby absorbing some of the kinetic energy in the vibration. Floating piston 219 is free to move in response to the compression of oil in oil reservoir 221 as piston 213 is moved by rod 211.

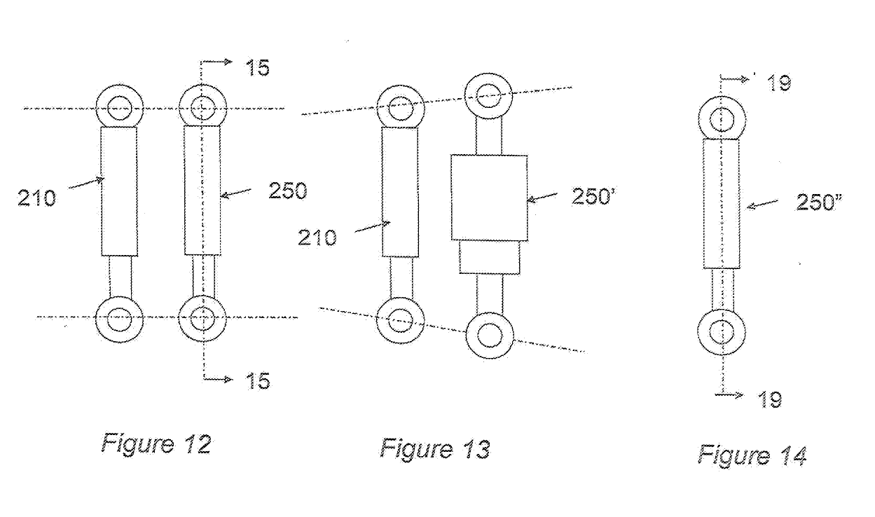

Referring to FIG. 12, an electromagnetic shock absorber 250 may be placed in mechanical parallel with conventional mechanical shock absorber 210 to convert a portion of the kinetic energy of vibrations experienced by the shock absorbers 210 and 250 into electrical energy. As shown in FIG. 12, electromagnetic shock absorber 250 may be configured to be of the same length and diameter as conventional mechanical shock absorber 210 and may be extended between the same components as conventional mechanical shock absorber 210 in adjacent mounting locations. Alternatively, as shown in FIG. 13, electromagnetic shock absorber 250 may be configured differently than conventional mechanical shock absorber 210 and may be extended between different components of a suspension system or at mounting points experiencing a different amount of displacement than conventional technical shock absorber 210. For some applications in particular, it may be desirable to intentionally use a leveraging system so that electromagnetic shock absorber 250′ and conventional mechanical shock absorber 210 experience different force levels in response to vibration to optimize their load absorbing or electrical energy generating characteristics.

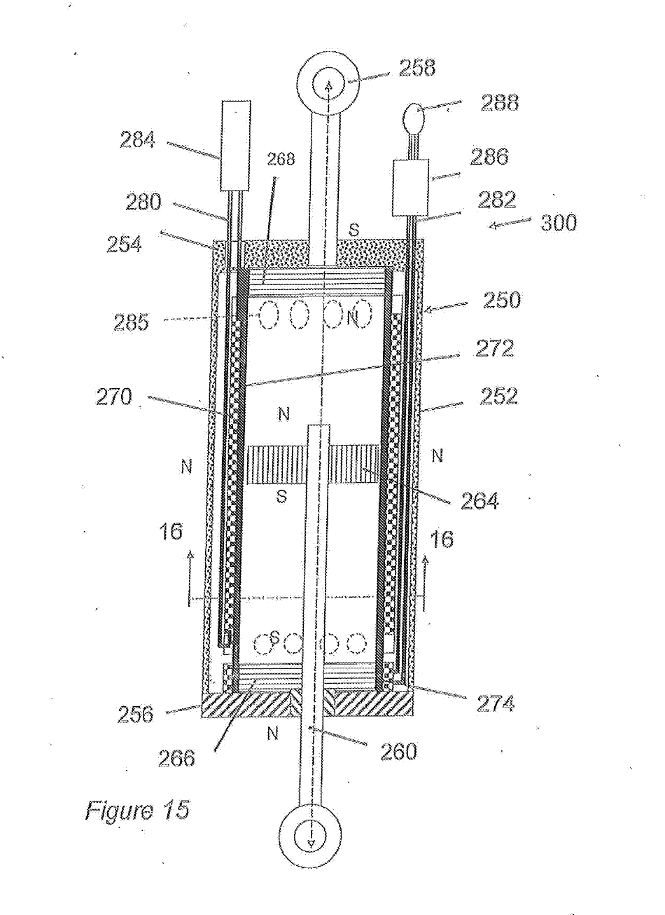

Alternatively, as shown in FIG. 14 an electromagnetic shock absorber 250″ may be manufactured to the same dimensions as a conventional mechanical shock absorber and have shock absorbing components incorporated therein, as described in detail later herein. Electromechanical shock absorber 250″ may therefore be substituted for a conventional mechanical shock absorber in a suspension system since it offers the functionality of both types of shock absorbers.

Referring now generally to FIGS. 15-21 various exemplary electromagnetic shock absorbers 250, 250′, 250″ and 250a are illustrated and the general arrangement of the mechanical, magnetic and electromagnetic components of energy management system 300 will be described.

Referring generally to FIGS. 15-17, schematically illustrating a generalized electromechanical shock absorber 250, and more particularly to FIG. 15, illustrating a section through shock absorber 250, the arrangement of the magnetic and electromagnetic components will be described. In particular, electromechanical shock absorber 250 includes a cylinder 252 having an upper end wall 254 and a lower end wall 256. A first rod 258 is fixed to the upper end 254 connectable to a first suitable mounting point on a suspension system. A second rod 260, connectable to second suitable mounting point of a suspension system, is inserted through an aperture in the lower end wall 256 and is reciprocal relative to cylinder 252.

A magnetic piston 264 is mounted to rod 260 within cylinder 252 and is constrained to oscillate within cylinder 252 in response to relative movement between the first and second mounting points of the suspension system. Magnetic piston 264 may be press fitted to rod 260 or secured thereto by other means, such as clips. Magnetic piston 264 may be a complex magnet having an axial magnetic component and a radial magnetic component, as illustrated and described in related U.S. patent application Ser. No. 61/171,641 and PCT patent application Serial No. PCT/US10/32,037 described above and incorporated by reference herein.

An optional pair of axial magnets 266 and 268 may be disposed within cylinder 252 adjacent walls 254 and 256. Magnets 266 and 268 and magnetic piston 264 are oriented to present faces to each other of opposite polarity. Magnets 268 and 266 may be used to assist in the orientation of magnet piston 264 and to manage the oscillatory motion of magnet piston 264.

A winding, such as a toroidal winding 270, is provided within cylinder 252, which may be protected from magnetic piston 264 by a cylindrical wall 272. Magnetic piston 264 extends nearly to wall 272. For some applications, it may be desirable for magnetic piston 264 to form a sliding seal with wall 272. It will be appreciated that oscillatory motion of magnetic piston 264 within cylinder 252 will cause a current to flow in toroidal winding 270, thus permitting the winding to convert the kinetic energy of vibrations in the suspension system to electrical energy which may be used by the vehicle. Conversely driving a current through toroidal winding 270 will impart a force on a magnetic piston 264, causing relative motion between rods 258 and 260, which may in turn deliver a force to the components of the suspension system to manage the oscillatory motion there between.

Electromechanical shock absorber 250 optionally includes another toroidal winding 274 disposed adjacent axial magnet 266. Toroidal winding 274 may also be selectively energized to temporally exert a force on magnetic piston 264 to initiate or assist the oscillation of magnetic piston 264. Wires 280 and 282 connected respectively to toroidal winding 270 and 274 extend from cylinder 252 to an external load 284 for the use of the current generated in winding 270 and connect toroidal windings 272 and 274 to an external source of power 286 and controller 288 for selectively powering the windings.

Cylinder 252 may be provided with apertures 285 for admission of air to cool the internal components and to regulate the buildup of air pressure on opposing sides of magnetic piston 264.

Electromechanical shock absorber 250 may be configured to provide either alternating current or direct current output. Electrical load 284 may be one or more electrical devices capable of consuming the power, one or more storage devices used to store power for later use, or a power distribution system. Exemplary storage devices for electrical load 284 may include the vehicle main battery or a local battery for use by controller 288 and may therefore be the same component as power source 286.

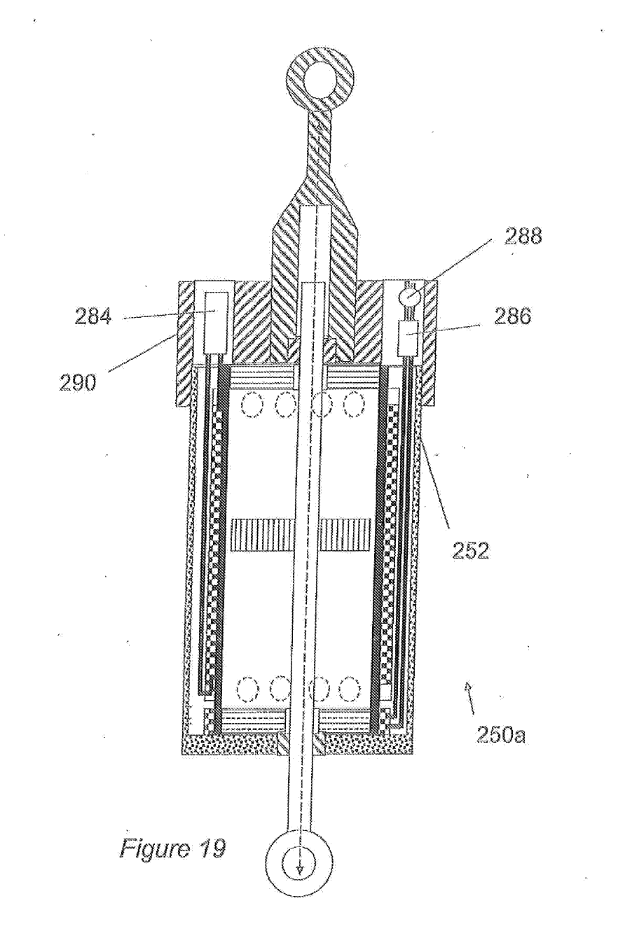

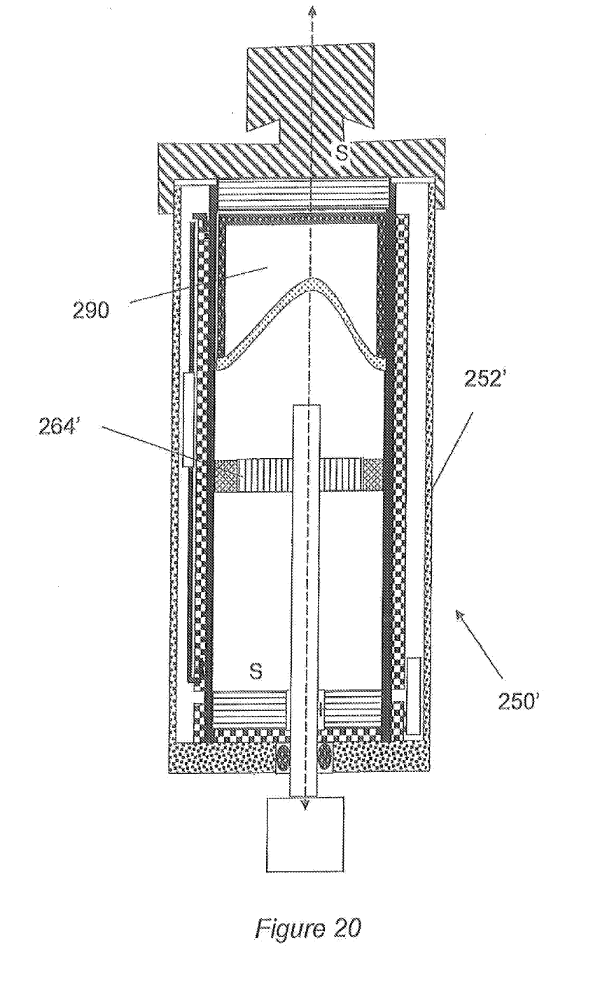

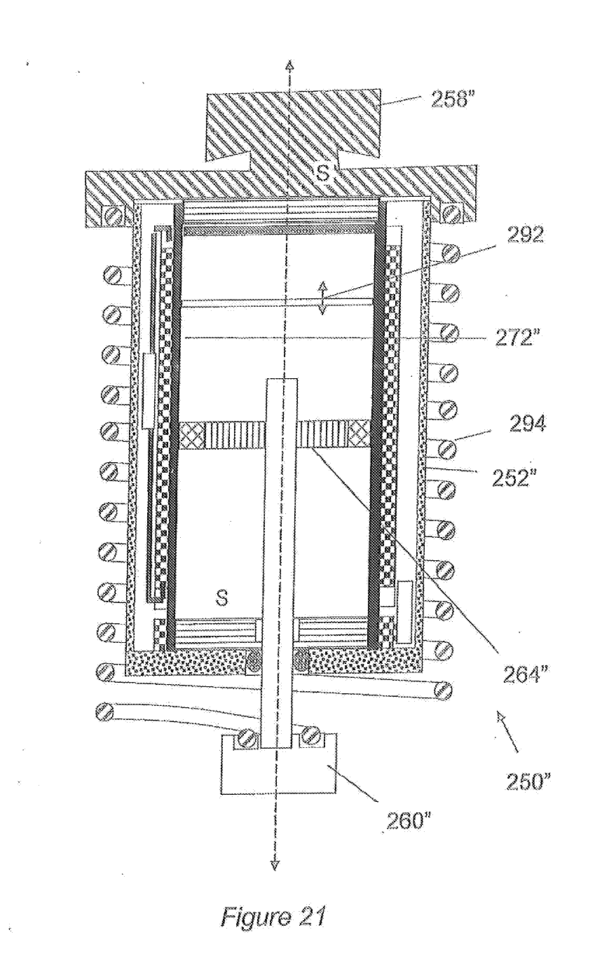

While power source 286 controller 288, and electrical load 284 are schematically illustrated as independent of electromechanical shock absorber 250, either or both may be integrated with an electromechanical shock absorber 250a of FIGS. 14 and 19 as best shown in FIG. 20 and described below. In particular, one or both may alternatively be affixed to a cover 290 mounted over one end of cylinder 252.

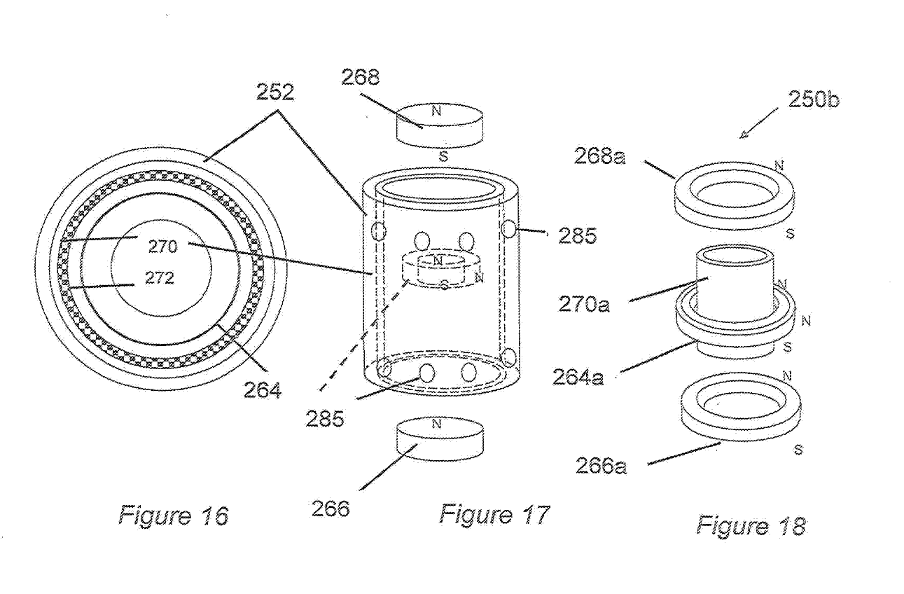

FIG. 18 schematically illustrates an alternative electromechanical shock absorber 250b, in which the arrangement of the magnetic and electromagnetic components is similar to those described above, except that piston 264a and axial magnets 266a and 268a are ring-shaped. In this arrangement, piston 264a is disposed outside of the toroidal winding 270a. Magnetic piston 264a interacts with axial magnets 268a and 266a and toroidal winding 270a according to the same principles as the similarly numbered components of the electromechanical shock absorber 250 of FIGS. 15 and 16 described above.

Still other configurations are possible. For example, FIG. 20 schematically illustrates an alternative electromechanical shock absorber 250′ in which a mechanical vibration absorbing system has been included. In particular, a fluid compartment 290 surrounded by wall 272′ resiliently flexes and absorbs some vibration in response to the pressure caused by the movement of piston 264′. FIG. 21 schematically illustrates another alternative electromechanical shock absorber 250″, in which a mechanical vibration absorbing system and a spring 294 has been included. In particular, a floating piston 292 engages wall 272″ and is displaceable in response to the pressure caused by the movement of piston 264″ to absorb some vibration between rods 258 and 260″. A spring 294 wound around the outside of cylinder 252″ and connected to rods 25811 and 260″ is provided in mechanical parallel arrangement with shock absorber 250″.

It should be noted that a plurality of toroidal windings may be provided. One or more passive toroidal windings may be provided to create an output current as a function of the motion of piston 264, 264′ or 264a. One or more active toroidal windings may also be provided to create a magnetic field opposing the magnetic field of piston 264, 264′ or 264″ for selectively driving the piston when active oscillation management is desired. The passive toroidal winding may be significantly larger than the active toroidal winding. As described above, the energy created by piston 264, 264′ or 264a interacting with a passive toroidal winding may be transferred to and stored in an electrical storage device 284, such as a battery or capacitor. An active toroidal winding may use the electrical energy previously created by the moving piston magnets interacting with the passive toroidal winding and subsequently stored in electrical storage device 284. The toroidal windings may be wound about and supported by wall 272 or by a tube formed of a suitable non-conductive material such as plastic.

It will be appreciated that electromechanical shock absorbers 250, 250′ and 250″ may be used in other applications such as non-vehicular applications, as a generator, a motor, a pump, a compressor, an engine, or an electrical power transformer. When used as a transformer, electrical power may be input to passive toroidal windings and electrical power may be output from active toroidal windings, when used as a generator, mechanical power may be input by reciprocally moving the rods relative to each other and electrical power may be output from a passive toroidal winding. The output of the energy conversion device can be configured to be direct or alternating current. The mechanical motion may be provided, for example, by any source that is capable of oscillating the shock absorber along its longitudinal axis. Alternatively, mechanical motion may be imparted to the magnetic piston by application of a current to an active winding. The mechanical motion may be used to drive a compressor or a pump. Alternatively, a compressor or pump may be incorporated into the shock absorber. For example, the magnetic piston may sealingly engage the sides of the cylindrical wall and the two ends of the housing may have openings, to allow the movement of air or a fluid pumped by the movement of the piston.

An electromechanical shock absorber may be configured as a single stage having a single set of axial magnets, a single set of toroidal windings, and a single piston as described above. Alternatively, a device may have multiple stages, each with at least its own piston, which may operate in series, in parallel, or independently. When constructed with multiple stages, the individual stages may share components, such as outer or inner housings. Alternatively, multiple energy conversion devices may be connected electrically or mechanically in parallel or in series.

For active implementation, a control algorithm may be provided capable of analyzing the vibration characteristics of the surface and applying a current to the winding to provide piston deceleration and acceleration to tune the response of the shock absorber 250 to the terrain. The system may be designed to self-adjust to changing road conditions.

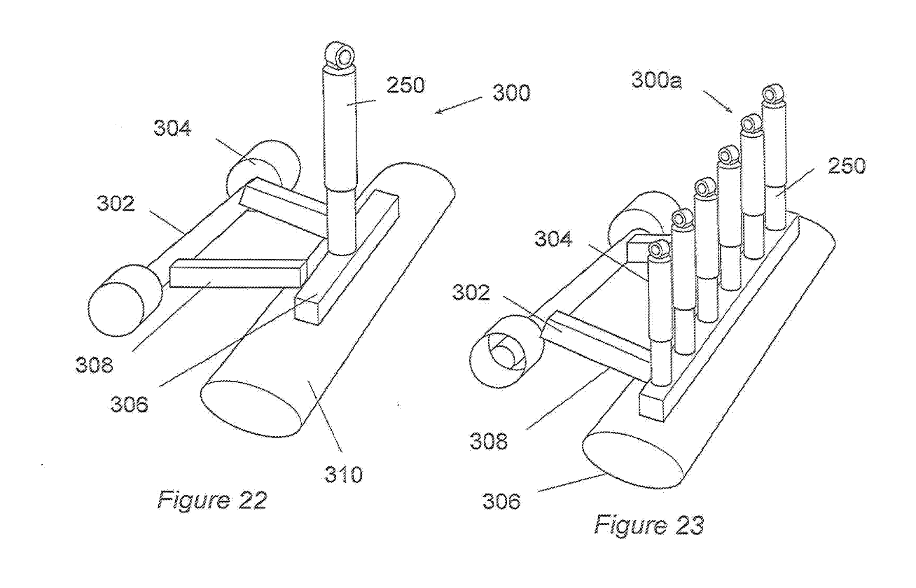

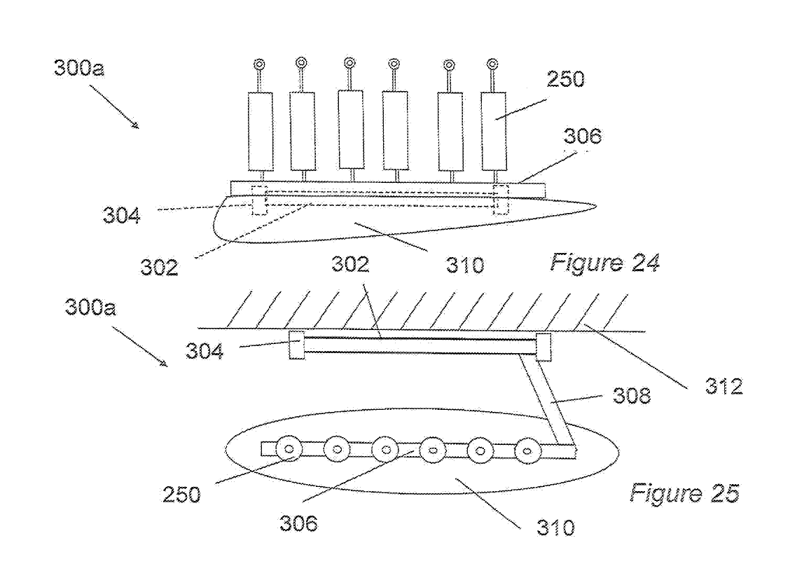

Referring now generally to FIGS. 22-27 various exemplary marine versions of a kinetic energy management system similar one of the kinetic energy management systems described above are illustrated and the general arrangement of the mechanical, magnetic and electromagnetic components of kinetic energy management system 300 will be described.

Referring to FIG. 22 an exemplary kinetic energy management system 300 using a single electromagnetic shock absorber 250 is illustrated for attachment to a boat shock absorber 250 may be any of the exemplary shock absorbers described above. Kinetic energy management system 300 includes a frame structure including a shaft 302 having two or more wheels 304 for rolling engagement with the side of a boat, not shown in FIG. 22. A frame member 306 is secured parallel to shaft 302 by two or more cross members 308 extending between shaft 302 and frame member 306. Frame member 306 is attached to a top of a float such as a pontoon 310. An electromagnetic shock absorber 250 is connected at one end to frame member 306 and extends upwardly there from for interconnection with the side of a boat, not shown in FIG. 22.

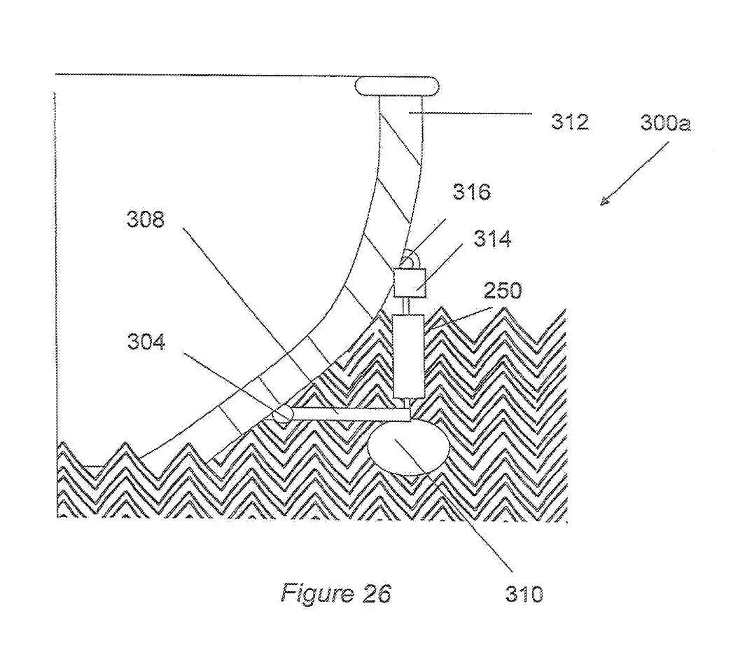

Referring to FIGS. 23-26, an exemplary kinetic energy management system 300a using a multiple electromagnetic shock absorbers 250 is illustrated for attachment to a boat 312 (see FIGS. 25 and 26). Kinetic energy management systems 300 may be attached to a boat 312 in a manner similar to that described for kinetic energy management systems 300a. The components of kinetic energy management system 300a include shaft 302, wheels 304, frame member 306, cross members 308 and pontoon 310, similar in form and function to those described above for kinetic energy management system 300, except that a plurality of electromagnetic shock absorbers 250 are each connected at one end to frame member 306 and extends upwardly there from for interconnection with the side of boat 312.

The upper end of each shock absorber 250 may be connected to the side of boat 310 by a spherical rod joint 316, as shown in FIG. 26, or an equivalent structure. Shaft 302 may be similarly attached to the side of boat 312 by a spherical rod joint or an equivalent structure. An elastomeric travel limiter or jounce stop 314 may be provided at the upper end of each shock absorber 250, as shown in FIG. 26, and designed to maintain torques within limits to avoid bending of components. Cross members 308 may be pivotally attached to frame member 306 so that shaft 302 and cross members 308 form a pivoting control arm for controlling the placement of pontoon 310 relative to side of boat 312. If desired, a third frame portion disposed at an angle above the pivoting control arm may be provided for additional securement to boat 312. Cross members 308 may be adjustable in length to accommodate differently shaped boats. Exemplary kinetic energy management system 300a may be installed so that shock absorbers 250 are generally perpendicular to the water, with the spherical rod joint assisting in fore-aft compliance.

Boat 312 may be provided with one or more kinetic energy management systems 300 or 300a on each side of the boat. It will be appreciated that the kinetic, energy management systems 300 or 300a on each side of the boat may generate electricity from wave action whether boat 312 is in motion or is resting at anchor or at a dock. Kinetic energy management systems 300 and 300a also limit fore-aft motion of boat 312(pitch) and side-to-side motion (roll) to provide stability to boat 312 due to the shape of pontoon 310. In particular, long properly designed pontoons function as outriggers while minimizing drag. One or more windings in shock absorbers 250 may be selectively powered to contract the shock absorbers and thereby raise the pontoon 310 from the water when desired.

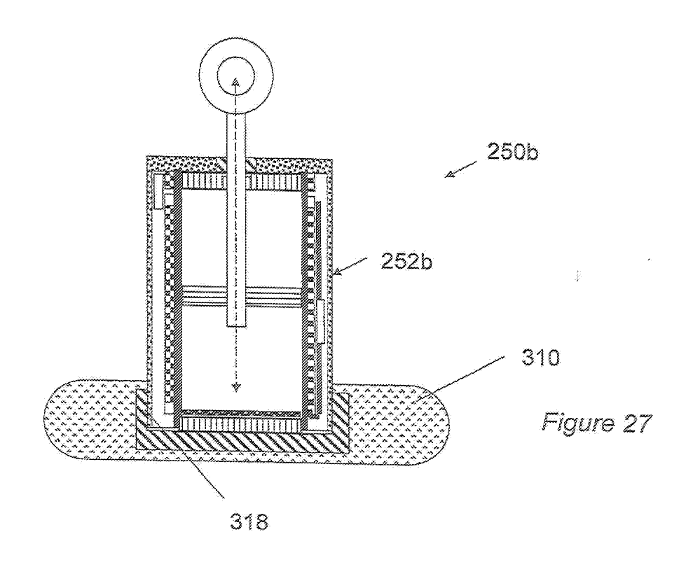

FIG. 27 illustrates yet another configuration for a kinetic energy management system wherein a cylinder 252b of a shock absorber 250b is fitted into a cavity 318 in a float 310 and affixed therein.

The above disclosure therefore provides a kinetic energy management system, the kinetic energy management system having a magnetic piston displaceable along a first longitudinal axis and a winding disposed about the first longitudinal axis to cyclically interact with the magnetic piston to induce an electrical current and voltage in the winding, thereby creating electrical energy. The system may have a plurality of said windings and plurality of magnetic pistons, each of said magnetic pistons cyclically imparting a magnetic field across one of said windings to contribute to the generation of electrical energy. The kinetic energy management system may have one of said magnet or said winding interconnected with a floatation component adapted for floating on the surface of a body of water and the other of and said magnet or winding interconnected with a boat whereby said kinetic energy management system may be used to manage the transverse vibration of the boat as it moves across the surface of the body of water. The flotation component may be a pontoon. Multiple shock absorbers may be mounted between the side of a boat and a pontoon. One or more kinetic management systems including a pontoon and a plurality of shock absorbers may be mounted on each side of a boat. The pontoons may be selectively raised from the water depending on conditions.

Features shown or described in association with one configuration may be added to or used alternatively in another configuration; including configurations described or illustrated in the provisional patent applications and the patent cooperation treaty patent application referred to in the above cross-reference to related applications. The scope of the device should be determined, not with reference to the above description, but should instead be determined with reference to the appended claims; along with the full scope of equivalents to which such claims are entitled. It is anticipated and intended that future developments will occur in the arts discussed herein, and that the disclosed systems and methods will be incorporated into such future configurations. In sum, it should be understood that the device is capable of modification and variation and is limited only by the following claims.

All terms are intended to be given their broadest reasonable constructions and their ordinary meanings as understood by those skilled in the art unless an explicit indication to the contrary in made herein. In particular, use of the singular articles such as “a” and “the” should be read to recite one or more of the indicated elements unless a claim recites an explicit limitation to the contrary.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicular kinetic energy management system comprising:
a first main body having a passive magnetic component movable therewith;
a second main body movably attached to the first main body for reciprocal movement there between, the second main body having an active magnetic component movable therewith and positioned such as to magnetically communicate with the passive magnetic component;
one of the first and second main bodies being adapted for engagement with a vehicular component that experiences irregularities of a surface on which a vehicle travels; and
the other of said first and second main bodies being adapted for engagement with a load bearing portion of the vehicle for which isolation from vibrations due to irregularities of the surface on which the vehicle travels is desired, such that interaction of the active and passive magnetic component in response to relative movement of the first and second main bodies translates between reciprocating kinetic energy associated with motion of the vehicle over the irregularities of the surface and electrical energy associated with the active magnetic component.

2. A vehicular kinetic energy management system according to claim 1 wherein the active magnetic component is a winding.

3. A vehicular kinetic energy management system according to claim 1 wherein the passive magnetic component is a permanent magnet.

4. A vehicular kinetic energy management system according to claim 1 further comprising two spaced apart fixed axial end magnets, the passive magnetic component being a magnetic piston having an axial magnetic field component, said magnetic piston being movably disposed between the two spaced apart fixed magnets and displaceable there between along a longitudinal axis.

5. A vehicular kinetic energy management system according to claim 4 further comprising a radial magnet disposed about the longitudinal axis, said magnetic piston further having a radial magnetic component.

6. A vehicular kinetic energy management system according to claim 4 further comprising a cylinder disposed about the longitudinal axis, said two spaced apart fixed axial end magnets being disposed adjacent opposing longitudinal ends of the cylinder and the passive magnetic component being movably disposed within the cylinder to reciprocate along the longitudinal axis between the two spaced apart fixed magnets.

7. A vehicular kinetic energy management system according to claim 4 wherein said active magnetic component comprises a winding disposed about the longitudinal axis.

8. A vehicular kinetic energy management system according to claim 1 further comprising:
a housing; and
a radial magnetic source affixed to the housing and an axial magnetic source affixed to the housing; and
wherein said passive magnetic component is disposed in the housing and includes an axial magnetic component responsive to the axial magnetic source and a radial magnetic component responsive to the radial magnetic source.

9. A vehicular kinetic energy management system according to claim 8 wherein said active magnetic component comprises a winding disposed within said housing.

10. A vehicular kinetic energy management system comprising:
a generally cylindrical housing defining a longitudinal axis;
a first main body fixedly secured to the housing;
a second main body movably secured to the housing for reciprocal movement relative to the housing along said longitudinal axis;
a magnetic piston movably disposed within said housing and attached to said second main body such as to be movable along the longitudinal axis;
a winding disposed within the housing about the longitudinal axis and communicating magnetically with the magnetic piston; and
a shock-absorbing component disposed between the first and second main bodies.

11. A vehicular kinetic energy management system according to claim 10 further comprising two spaced apart fixed axial end magnets disposed within the housing adjacent opposite ends of the longitudinal axis, the magnetic piston having an axial magnetic field component, said magnetic piston being movably disposed between the two spaced apart fixed magnets and displaceable there between along the longitudinal axis.

12. A vehicular kinetic energy management system according to claim 10 further comprising a radial magnet disposed about the longitudinal axis, said magnetic piston further having a radial magnetic component.

13. A vehicular kinetic energy management system according to claim 12 wherein said shock-absorbing component is selected from a spring and a shock-absorbing device.

14. A vehicular kinetic energy management system comprising:
a first main body;
a second main body movably secured to the first main body for reciprocal movement relative thereto along a longitudinal axis;
a magnetic piston attacked to said second main body such as to be movable along the longitudinal axis;
an active magnetic component disposed about the longitudinal axis and communicating magnetically with the magnetic piston; and
a flotation component attached to one of the first and second main bodies, the other of the first and second main bodies that is not attached to the flotation component being adapted for engagement with a boat.

15. A vehicular kinetic energy management system according to claim 14 further comprising an anchoring system mechanically disposed between the flotation component and the boat to maintain the longitudinal axis of the vehicular kinetic energy management system in a generally vertical direction.

16. A vehicular kinetic energy management system according to claim 15 wherein the anchoring system further comprises:
a frame member extending generally horizontally from the flotation component; and
an engagement surface at an end of the frame member adapted for moving engagement with the boat.

17. A vehicular kinetic energy management system according to claim 16 wherein the engagement surface comprises at least one wheel rotatably depending from the frame member.
